(19) United States
(12) Patent Application Publication
(10) Pub. No.: US 2015/0367238 A1
(43) Pub. Date: Dec. 24, 2015

(54) GAME SYSTEM, GAME APPARATUS, A METHOD OF CONTROLLING THE SAME, A PROGRAM, AND A STORAGE MEDIUM

(71) Applicant: SQUARE ENIX HOLDINGS CO., LTD., Shinjuku-ku, Tokyo (JP)

(72) Inventors: Cyril PERRIN, ANTONY (FR); Alex TAIT, Montreal (CA)

(73) Assignee: SQUARE ENIX HOLDINGS CO., LTD., Tokyo (JP)

(21) Appl. No.: 14/655,826

(22) PCT Filed: Jan. 30, 2014
(86) PCT No.: PCT/JP2014/052707

§ 371 Date: Jun. 26, 2015

Related U.S. Application Data
(60) Provisional application No. 61/761,374, filed on Feb. 6, 2013.

(51) Int. Cl. A63F 13/73; A63F 13/30

(52) U.S. Cl. CPC A63F 13/73; A63F 13/30

(57) ABSTRACT

A game apparatus obtains in a case where a state saving request is received, information specifying a condition in a game corresponding to that request and state information for initiating a game in a same state as a game screen corresponding to that request and records state saving data associated with the condition information and the state information. The game apparatus provides, in a case where a state saving data sharing request is received, link information of the recorded state saving data and condition information for that data, to another device.

### TECHNICAL FIELD

The present invention relates to a game system, a game apparatus, a method of controlling the same, a program, and a storage medium, and particularly to a technique for sharing save data.

### BACKGROUND ART

The video game industry has seen considerable evolution, from the introduction of stand-alone arcade games, to home-based computer games, to the emergence of games made for specialized consoles. Widespread public access to the Internet then led to another major development, namely “cloud gaming”. In a cloud gaming system, a player can utilize an ordinary Internet-enabled appliance such as a smartphone or tablet to connect to a video game server over the Internet. The video game server starts a session for the player, and may do so for multiple players. The video game server renders video data and generates audio for the player based on player actions (e.g., moves, selections) and other attributes of the game. Encoded video and audio is delivered to the player's device over the Internet, and is reproduced as visible images and audible sounds. In this way, players from anywhere in the world can play a video game without the use of specialized video game consoles, software or graphics processing hardware.

Against this backdrop, new functionalities or features that have the potential to enhance the gaming experience would be welcomed by the industry.

### SUMMARY OF INVENTION

The present invention was made in view of such problems in the conventional technique. The present invention provides a game system capable of providing state saving data easily to another device, a game apparatus, a method of controlling the same, a program, and a storage medium.

The present invention in its first aspect provides a game system for executing games for each of a plurality of client devices, and providing game screens for an executing game to a corresponding client device, the system comprising: execution means for executing processing for a game, and generating game screens; condition obtaining means for obtaining, in a case where a state saving request is received, condition information specifying a condition in a game corresponding to that request; state obtaining means for obtaining, in a case where the state saving request is received, state information for initiating a game in a same state as a game screen corresponding to that request; recording means for recording the condition information and the state information as state saving data; and provision means for providing, in a case where a state saving data sharing request is received, link information of the state saving data recorded by the recording means and condition information for that data, to a client device different from a client device to which a game screen corresponding to that state saving data was provided, wherein in a case where an access request based on the link information of the state saving data is received from the client device to which the link information of that state saving data provided by the provision means, the execution means obtains that state saving data, and executes processing for the game from a same state as that of a game screen corresponding to that state saving data.

The present invention in its second aspect provides a game apparatus for executing a game, the apparatus comprising: execution means for executing processing for a game, and generating game screens; condition obtaining means for obtaining, in a case where a state saving request is received, information specifying a condition in a game corresponding to that request; state obtaining means for obtaining, in a case where the state saving request is received, state information for initiating a game in a same state as a game screen corresponding to that request; recording means for recording state saving data associated with the condition information and the state information; and provision means for providing, in a case where a state saving data sharing request is received, link information of the state saving data recorded by the recording means and condition information for that data, to an external device.

The present invention in its third aspect provides a method of controlling a game apparatus for executing a game, the method comprising: an execution step of executing processing for a game, and generating game screens; a condition obtaining step of obtaining, in a case where a state saving request is received, condition information specifying a condition in a game corresponding to that request; a state obtaining step of obtaining, in a case where the state saving request is received, state information for initiating a game in a same state as a game screen corresponding to that request; a recording step of recording state saving data associated with the condition information and the state information; and a provision step of providing, in a case where a state saving data sharing request is received, link information of the state saving data recorded in the recording step and condition information for that data, to an external device.

Further features of the present invention will become apparent from the following description of exemplary embodiments (with reference to the attached drawings).

### BRIEF DESCRIPTION OF DRAWINGS

FIG. 1A is a block diagram of a cloud-based video game system architecture including a server system, according to a non-limiting embodiment of the present invention.

FIG. 1B is a block diagram of the cloud-based video game system architecture of FIG. 1A, showing interaction with the set of client devices over the data network during game play, according to a non-limiting embodiment of the present invention.

FIG. 2A is a block diagram showing various physical components of the architecture of FIG. 1B, according to a non-limiting embodiment of the present invention.

FIG. 2B is a variant of FIG. 2A.

FIG. 2C is a block diagram showing various functional modules of the server system in the architecture of FIG. 1B, which can be implemented by the physical components of FIG. 2A or 2B and which may be operational during game play.

FIGS. 3A to 3C are flowcharts showing execution of a set of processes carried out during execution of a video game, in accordance with non-limiting embodiments of the present invention.

FIGS. 4A and 4B are flowcharts showing operation of a client device to process received video and audio, respectively, in accordance with non-limiting embodiments of the present invention.

FIG. 5 is a block diagram showing a functional configuration of a server side according to embodiments of the present invention.

FIG. 6 is a flowchart showing an example of state saving processing performed on the server side according to embodiments of the present invention.

FIGS. 7A and 7B are views showing examples of a data configuration of state saving data according to embodiments of the present invention.

FIG. 8 is a flowchart showing an example of state sharing processing performed on the server side according to embodiments of the present invention.

FIG. 9 is a view showing an example of a data configuration of a sharing instruction according to embodiments of the present invention.

FIG. 10 is a view showing an example of a publishing list of state saving data according to embodiments of the present invention.

### DESCRIPTION OF EMBODIMENTS

I. Cloud Gaming Architecture

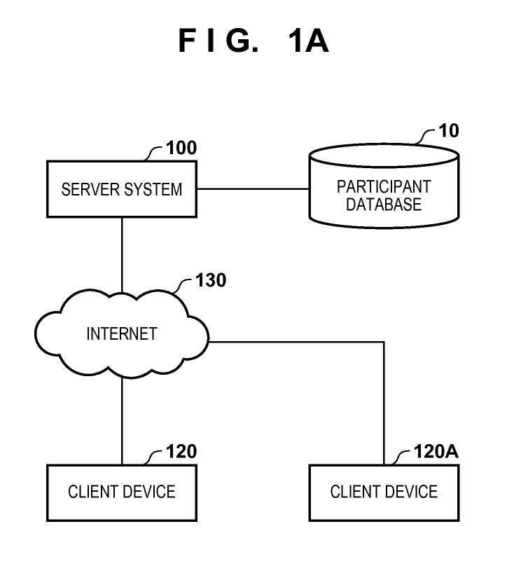

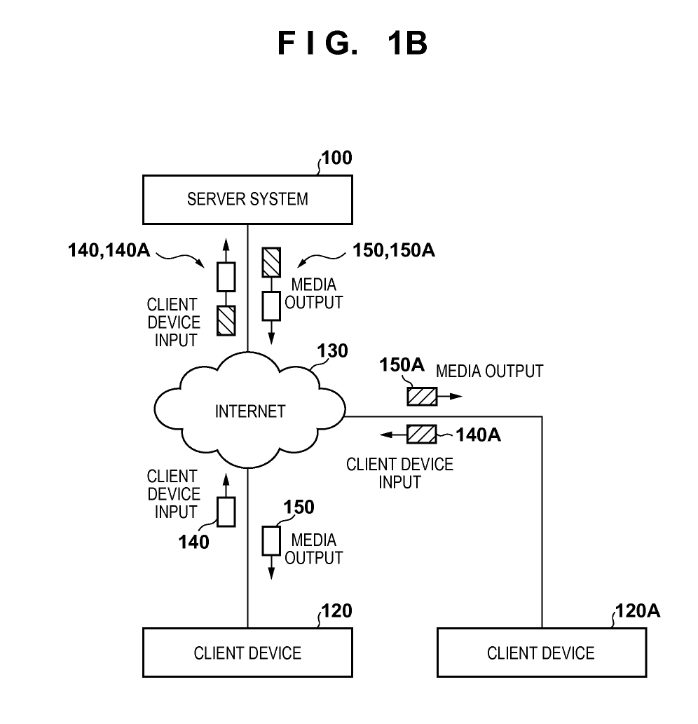

FIG. 1A schematically shows a cloud-based video game system architecture according to a non-limiting embodiment of the present invention. The architecture may include client devices 120, 120A connected to a server system 100 over a data network such as the Internet 130. Although only two client devices 120, 120A are shown, it should be appreciated that the number of client devices in the cloud-based video game system architecture is not particularly limited.

The configuration of the client devices 120, 120A is not particularly limited. In some embodiments, one or more of the client devices 120, 120A may be, for example, a personal computer (PC), a home game machine (console such as XBOX™, PS3™, Wii™, etc.), a portable game machine, a smart television, a set-top box (STB), etc. In other embodiments, one or more of the client devices 120, 120A may be a communication or computing device such as a mobile phone, a personal digital assistant (PDA), or a tablet.

Each of the client devices 120, 120A may connect to the Internet 130 in any suitable manner, including over a respective local access network (not shown). The server system 100 may also connect to the Internet 130 over a local access network (not shown), although the server system 100 may connect directly to the Internet 130 without the intermediary of a local access network. Connections between the cloud gaming server system 100 and one or more of the client devices 120, 120A may comprise one or more channels. These channels can be made up of physical and/or logical links, and may travel over a variety of physical media, including radio frequency, fiber optic, free-space optical, coaxial and twisted pair. The channels may abide by a protocol such as UDP or TCP/IP. Also, one or more of the channels may be supported a virtual private network (VPN). In some embodiments, one or more of the connections may be session-based.

The server system 100 may enable users of the client devices 120, 120A to play video games, either individually (i.e., a single-player video game) or in groups (i.e., a multi-player video game). The server system 100 may also enable users of the client devices 120, 120A to spectate games being played by other players. Non-limiting examples of video games may include games that are played for leisure, education and/or sport. A video game may but need not offer participants the possibility of monetary gain.

The server system 100 may also enable users of the client devices 120, 120A to test video games and/or administer the server system 100.

The server system 100 may include one or more computing resources, possibly including one or more game servers, and may comprise or have access to one or more databases, possibly including a participant database 10. The participant database 10 may store account information about various participants and client devices 120, 120A, such as identification data, financial data, location data, demographic data, connection data and the like. The game server(s) may be embodied in common hardware or they may be different servers that are connected via a communication link, including possibly over the Internet 130. Similarly, the database(s) may be embodied within the server system 100 or they may be connected thereto via a communication link, possibly over the Internet 130.

The server system 100 may implement an administrative application for handling interaction with client devices 120, 120A outside the game environment, such as prior to game play. For example, the administrative application may be configured for registering a user of one of the client devices 120, 120A in a user class (such as a “player”, “spectator”, “administrator” or “tester”), tracking the user's connectivity over the Internet, and responding to the user's command(s) to launch, join, exit or terminate an instance of a game, among several non-limiting functions. To this end, the administrative application may need to access the participant database 10.

The administrative application may interact differently with users in different user classes, which may include “player”, “spectator”, “administrator” and “tester”, to name a few non-limiting possibilities.

Thus, in one example, the administrative application may interface with a player (i.e., a user in the “player” user class) to allow the player to set up an account in the participant database 10 and select a video game to play. Pursuant to this selection, the administrative application may invoke a server-side video game application. The server-side video game application may be defined by computer-readable instructions that execute a set of functional modules for the player, allowing the player to control a character, avatar, race car, cockpit, etc. within a virtual world of a video game. In the case of a multi-player video game, the virtual world may be shared by two or more players, and one player's game play may affect that of another.

In another example, the administrative application may interface with a spectator (i.e., a user in the “spectator” user class) to allow the spectator to set up an account in the participant database 10 and select a video game from a list of ongoing video games that the user may wish to spectate. Pursuant to this selection, the administrative application may invoke a set of functional modules for that spectator, allowing the spectator to observe game play of other users but not to control active characters in the game. (Unless otherwise indicated, where the term “participant” is used, it is meant to apply equally to both the “player” user class and the “spectator” user class.)

In a further example, the administrative application may interface with an administrator (i.e., a user in the “administrator” user class) to allow the administrator to change various features of the game server application, perform updates and manage player/spectator accounts.

In yet another example, the game server application may interface with a tester (i.e., a user in the “tester” user class) to allow the tester to select a video game to test. Pursuant to this selection, the game server application may invoke a set of functional modules for the tester, allowing the tester to test the video game.

FIG. 1B illustrates interaction that may take place between client devices 120, 120A and the server system 100 during game play, for users in the “player” or “spectator” user class.

In some non-limiting embodiments, the server-side video game application may cooperate with a client-side video game application, which can be defined by a set of computer-readable instructions executing on a client device, such as client device 120 or 120A. Use of a client-side video game application may provide a customized interface for the participant to play or spectate the game and access game features. In other non-limiting embodiments, the client device does not feature a client-side video game application that is directly executable by the client device. Rather, a web browser may be used as the interface from the client device's perspective. The web browser may itself instantiate a client-side video game application within its own software environment so as to optimize interaction with the server-side video game application.

It should be appreciated that a given one of the client devices 120, 120A may be equipped with one or more input devices (such as a touch screen, a keyboard, a game controller, a joystick, etc.) to allow users of the given client device to provide input and participate in a video game. In other embodiments, the user may produce body motion or may wave an external object; these movements are detected by a camera or other sensor (e.g., Kinect™), while software operating within the given client device attempts to correctly guess whether the user intended to provide input to the given client device and, if so, the nature of such input. The client-side video game application running (either independently or within a browser) on the given client device may translate the received user inputs and detected user movements into “client device input”, which may be sent to the cloud gaming server system 100 over the Internet 130.

In the illustrated embodiment of FIG. 1B, client device 120 may produce client device input 140, while client device 120A may produce client device input 140A. The server system 100 may process the client device input 140, 140A received from the various client devices 120, 120A and may generate respective “media output” 150, 150A for the various client devices 120, 120A. The media output 150, 150A may include a stream of encoded video data (representing images when displayed on a screen) and audio data (representing sound when played via a loudspeaker). The media output 150, 150A may be sent over the Internet 130 in the form of packets. Packets destined for a particular one of the client devices 120, 120A may be addressed in such a way as to be routed to that device over the Internet 130. Each of the client devices 120, 120A may include circuitry for buffering and processing the media output in the packets received from the cloud gaming server system 100, as well as a display for displaying images and a transducer (e.g., a loudspeaker) for outputting audio. Additional output devices may also be provided, such as an electro-mechanical system to induce motion.

It should be appreciated that a stream of video data can be divided into “frames”. The term “frame” as used herein does not require the existence of a one-to-one correspondence between frames of video data and images represented by the video data. That is to say, while it is possible for a frame of video data to contain data representing a respective displayed image in its entirety, it is also possible for a frame of video data to contain data representing only part of an image, and for the image to in fact require two or more frames in order to be properly reconstructed and displayed. By the same token, a frame of video data may contain data representing more than one complete image, such that N images may be represented using M frames of video data, where M<N.

II. Cloud Gaming Server System 100 (Distributed Architecture)

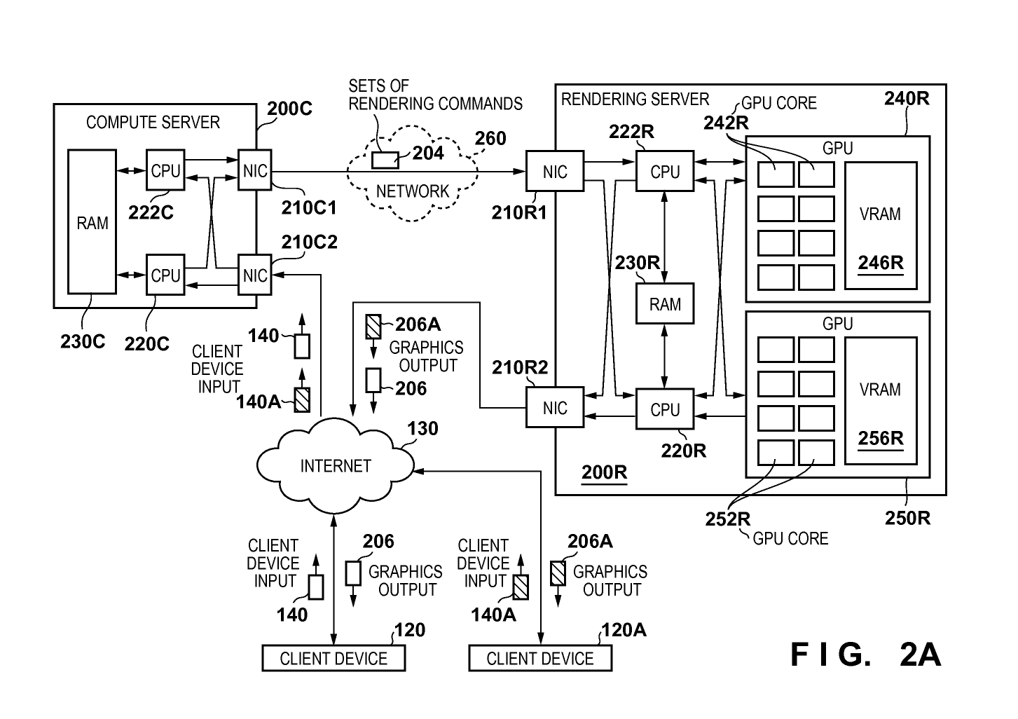

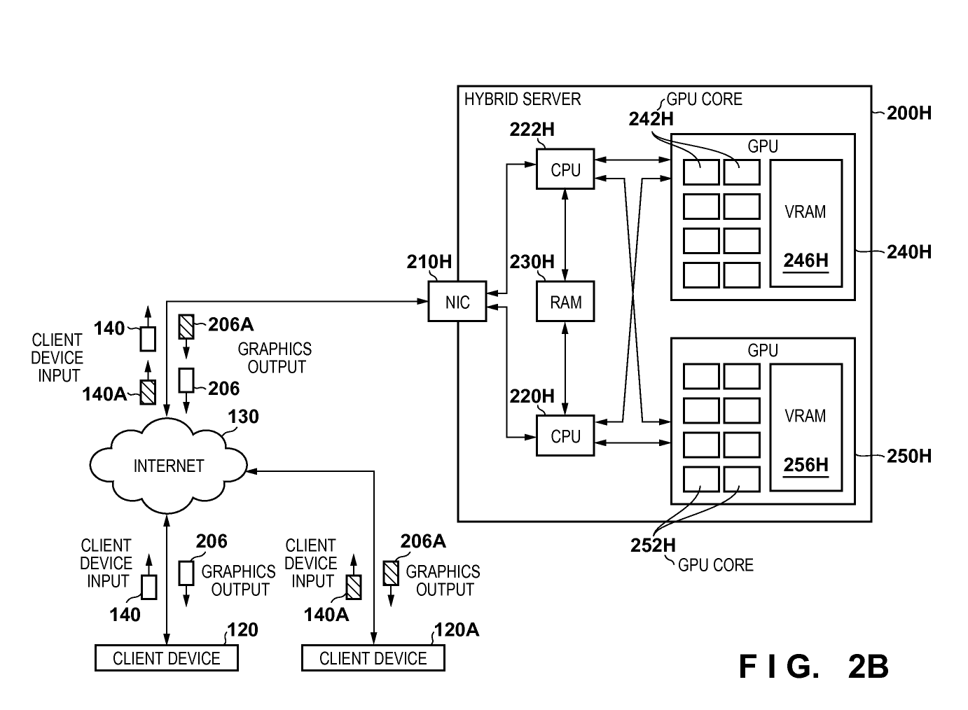

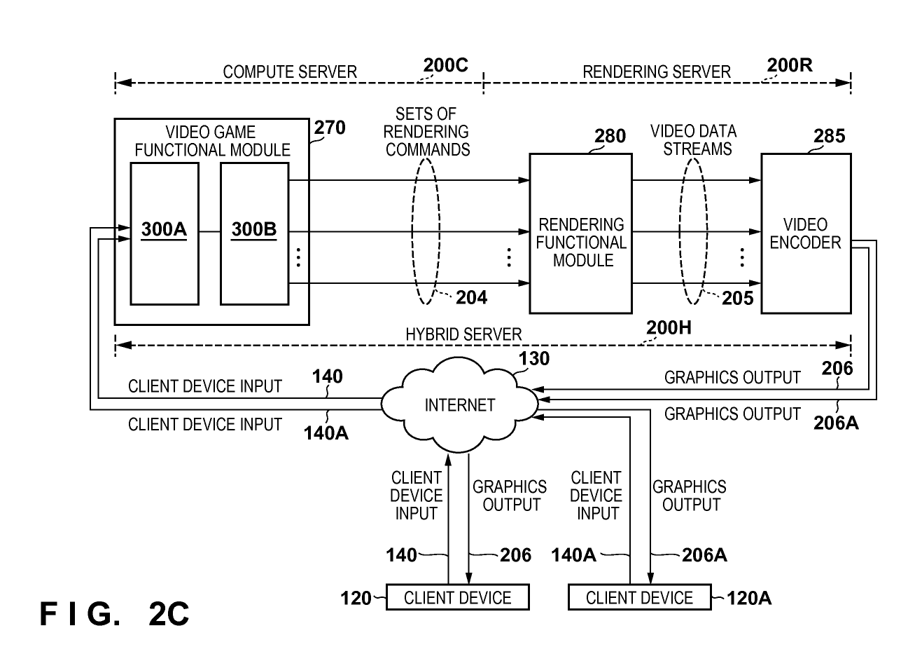

FIG. 2A shows one possible non-limiting physical arrangement of components for the cloud gaming server system 100. In this embodiment, individual servers within the cloud gaming server system 100 may be configured to carry out specialized functions. For example, a compute server 200C may be primarily responsible for tracking state changes in a video game based on user input, while a rendering server 200R may be primarily responsible for rendering graphics (video data).

For the purposes of the presently described example embodiment, both client device 120 and client device 120A are assumed to be participating in the video game, either as players or spectators. However, it should be understood that in some cases there may be a single player and no spectator, while in other cases there may be multiple players and a single spectator, in still other cases there may be a single player and multiple spectators and in yet other cases there may be multiple players and multiple spectators.

For the sake of simplicity, the following description refers to a single compute server 200C connected to a single rendering server 200R. However, it should be appreciated that there may be more than one rendering server 200R connected to the same compute server 200C, or more than one compute server 200C connected to the same rendering server 200R. In the case where there are multiple rendering servers 200R, these may be distributed over any suitable geographic area.

As shown in the non-limiting physical arrangement of components in FIG. 2A, the compute server 200C may comprise one or more central processing units (CPUs) 220C, 222C and a random access memory (RAM) 230C. The CPUs 220C, 222C can have access to the RAM 230C over a communication bus architecture, for example. While only two CPUs 220C, 222C are shown, it should be appreciated that a greater number of CPUs, or only a single CPU, may be provided in some example implementations of the compute server 200C. The compute server 200C may also comprise a network interface component (NIC) 210C2, where client device input is received over the Internet 130 from each of the client devices participating in the video game. In the presently described example embodiment, both client device 120 and client device 120A are assumed to be participating in the video game, and therefore the received client device input may include client device input 140 and client device input 140A.

The compute server 200C may further comprise another network interface component (NIC) 210C1, which outputs a sets of rendering commands 204. The sets of rendering commands 204 output from the compute server 200C via the NIC 210C1 may be sent to the rendering server 200R. In one embodiment, the compute server 200C may be connected directly to the rendering server 200R. In another embodiment, the compute server 200C may be connected to the rendering server 200R over a network 260, which may be the Internet 130 or another network. A virtual private network (VPN) may be established between the compute server 200C and the rendering server 200R over the network 260.

At the rendering server 200R, the sets of rendering commands 204 sent by the compute server 200C may be received at a network interface component (NIC) 210R1 and may be directed to one or more CPUs 220R, 222R. The CPUs 220R, 222R may be connected to graphics processing units (GPUs) 240R, 250R. By way of non-limiting example, GPU 240R may include a set of GPU cores 242R and a video random access memory (VRAM) 246R. Similarly, GPU 250R may include a set of GPU cores 252R and a video random access memory (VRAM) 256R. Each of the CPUs 220R, 222R may be connected to each of the GPUs 240R, 250R or to a subset of the GPUs 240R, 250R. Communication between the CPUs 220R, 222R and the GPUs 240R, 250R can be established using, for example, a communications bus architecture. Although only two CPUs and two GPUs are shown, there may be more than two CPUs and GPUs, or even just a single CPU or GPU, in a specific example of implementation of the rendering server 200R.

The CPUs 220R, 222R may cooperate with the GPUs 240R, 250R to convert the sets of rendering commands 204 into a graphics output streams, one for each of the participating client devices. In the present embodiment, there may be two graphics output streams 206, 206A for the client devices 120, 120A, respectively. This will be described in further detail later on. The rendering server 200R may comprise a further network interface component (NIC) 210R2, through which the graphics output streams 206, 206A may be sent to the client devices 120, 120A, respectively.

III. Cloud Gaming Server System 100 (Hybrid Architecture)

FIG. 2B shows a second possible non-limiting physical arrangement of components for the cloud gaming server system 100. In this embodiment, a hybrid server 200H may be responsible both for tracking state changes in a video game based on user input, and for rendering graphics (video data).

As shown in the non-limiting physical arrangement of components in FIG. 2B, the hybrid server 200H may comprise one or more central processing units (CPUs) 220H, 222H and a random access memory (RAM) 230H. The CPUs 220H, 222H may have access to the RAM 230H over a communication bus architecture, for example. While only two CPUs 220H, 222H are shown, it should be appreciated that a greater number of CPUs, or only a single CPU, may be provided in some example implementations of the hybrid server 200H. The hybrid server 200H may also comprise a network interface component (NIC) 210H, where client device input is received over the Internet 130 from each of the client devices participating in the video game. In the presently described example embodiment, both client device 120 and client device 120A are assumed to be participating in the video game, and therefore the received client device input may include client device input 140 and client device input 140A.

In addition, the CPUs 220H, 222H may be connected to a graphics processing units (GPUs) 240H, 250H. By way of non-limiting example, GPU 240H may include a set of GPU cores 242H and a video random access memory (VRAM) 246H. Similarly, GPU 250H may include a set of GPU cores 252H and a video random access memory (VRAM) 256H. Each of the CPUs 220H, 222H may be connected to each of the GPUs 240H, 250H or to a subset of the GPUs 240H, 250H. Communication between the CPUs 220H, 222H and the GPUs 240H, 250H may be established using, for example, a communications bus architecture. Although only two CPUs and two GPUs are shown, there may be more than two CPUs and GPUs, or even just a single CPU or GPU, in a specific example of implementation of the hybrid server 200H.

The CPUs 220H, 222H may cooperate with the GPUs 240H, 250H to convert the sets of rendering commands 204 into graphics output streams, one for each of the participating client devices. In this embodiment, there may be two graphics output streams 206, 206A for the participating client devices 120, 120A, respectively. The graphics output streams 206, 206A may be sent to the client devices 120, 120A, respectively, via the NIC 210H.

IV. Cloud Gaming Server System 100 (Functionality Overview)

During game play, the server system 100 runs a server-side video game application, which can be composed of a set of functional modules. With reference to FIG. 2C, these functional modules may include a video game functional module 270, a rendering functional module 280 and a video encoder 285. These functional modules may be implemented by the above-described physical components of the compute server 200C and the rendering server 200R (in FIG. 2A) and/or of the hybrid server 200H (in FIG. 2B). For example, according to the non-limiting embodiment of FIG. 2A, the video game functional module 270 may be implemented by the compute server 200C, while the rendering functional module 280 and the video encoder 285 may be implemented by the rendering server 200R. According to the non-limiting embodiment of FIG. 2B, the hybrid server 200H may implement the video game functional module 270, the rendering functional module 280 and the video encoder 285.

The present example embodiment discusses a single video game functional module 270 for simplicity of illustration. However, it should be noted that in an actual implementation of the cloud gaming server system 100, many video game functional modules similar to the video game functional module 270 may be executed in parallel. Thus, the cloud gaming server system 100 may support multiple independent instantiations of the same video game, or multiple different video games, simultaneously. Also, it should be noted that the video games can be single-player video games or multi-player games of any type.

The video game functional module 270 may be implemented by certain physical components of the compute server 200C (in FIG. 2A) or of the hybrid server 200H (in FIG. 2B). Specifically, the video game functional module 270 may be encoded as computer-readable instructions that are executable by a CPU (such as the CPUs 220C, 222C in the compute server 200C or the CPUs 220H, 222H in the hybrid server 200H). The instructions can be tangibly stored in the RAM 230C (in the compute server 200C) of the RAM 230H (in the hybrid server 200H) or in another memory area, together with constants, variables and/or other data used by the video game functional module 270. In some embodiments, the video game functional module 270 may be executed within the environment of a virtual machine that may be supported by an operating system that is also being executed by a CPU (such as the CPUs 220C, 222C in the compute server 200C or the CPUs 220H, 222H in the hybrid server 200H).

The rendering functional module 280 may be implemented by certain physical components of the rendering server 200R (in FIG. 2A) or of the hybrid server 200H (in FIG. 2B). In an embodiment, the rendering functional module 280 may take up one or more GPUs (240R, 250R in FIG. 2A, 240H, 250H in FIG. 2B) and may or may not utilize CPU resources.

The video encoder 285 may be implemented by certain physical components of the rendering server 200R (in FIG. 2A) or of the hybrid server 200H (in FIG. 2B). Those skilled in the art will appreciate that there are various ways in which to implement the video encoder 285. In the embodiment of FIG. 2A, the video encoder 285 may be implemented by the CPUs 220R, 222R and/or by the GPUs 240R, 250R. In the embodiment of FIG. 2B, the video encoder 285 may be implemented by the CPUs 220H, 222H and/or by the GPUs 240H, 250H. In yet another embodiment, the video encoder 285 may be implemented by a separate encoder chip (not shown).

In operation, the video game functional module 270 may produce the sets of rendering commands 204, based on received client device input. The received client device input may carry data (e.g., an address) identifying the video game functional module for which it is destined, as well as data identifying the user and/or client device from which it originates. Since the users of the client devices 120, 120A are participants in the video game (i.e., players or spectators), the received client device input may include the client device input 140, 140A received from the client devices 120, 120A.

Rendering commands refer to commands which may be used to instruct a specialized graphics processing unit (GPU) to produce a frame of video data or a sequence of frames of video data. Referring to FIG. 2C, the sets of rendering commands 204 result in the production of frames of video data by the rendering functional module 280. The images represented by these frames may change as a function of responses to the client device input 140, 140A that are programmed into the video game functional module 270. For example, the video game functional module 270 may be programmed in such a way as to respond to certain specific stimuli to provide the user with an experience of progression (with future interaction being made different, more challenging or more exciting), while the response to certain other specific stimuli will provide the user with an experience of regression or termination. Although the instructions for the video game functional module 270 may be fixed in the form of a binary executable file, the client device input 140, 140A is unknown until the moment of interaction with a player who uses the corresponding client device 120, 120A. As a result, there can be a wide variety of possible outcomes, depending on the specific client device input that is provided. This interaction between players/spectators and the video game functional module 270 via the client devices 120, 120A can be referred to as “game play” or “playing a video game”.

The rendering functional module 280 may process the sets of rendering commands 204 to create multiple video data streams 205. Generally, there may be one video data stream per participant (or, equivalently, per client device). When performing rendering, data for one or more objects represented in three-dimensional space (e.g., physical objects) or two-dimensional space (e.g., text) may be loaded into a cache memory (not shown) of a particular GPU 240R, 250R, 240H, 250H. This data may be transformed by the GPU 240R, 250R, 240H, 250H into data representative of a two-dimensional image, which may be stored in the appropriate VRAM 246R, 256R, 246H, 256H. As such, the VRAM 246R, 256R, 246H, 256H may provide temporary storage of picture element (pixel) values for a game screen.

The video encoder 285 may compress and encodes the video data in each of the video data streams 205 into a corresponding stream of compressed/encoded video data. The resultant streams of compressed/encoded video data, referred to as graphics output streams, may be produced on a per-client-device basis. In the present example embodiment, the video encoder 285 may produce graphics output stream 206 for client device 120 and graphics output stream 206A for client device 120A. Additional functional modules may be provided for formatting the video data into packets so that they can be transmitted over the Internet 130. The video data in the video data streams 205 and the compressed/encoded video data within a given graphics output stream may be divided into frames.

V. Generation of Rendering Commands

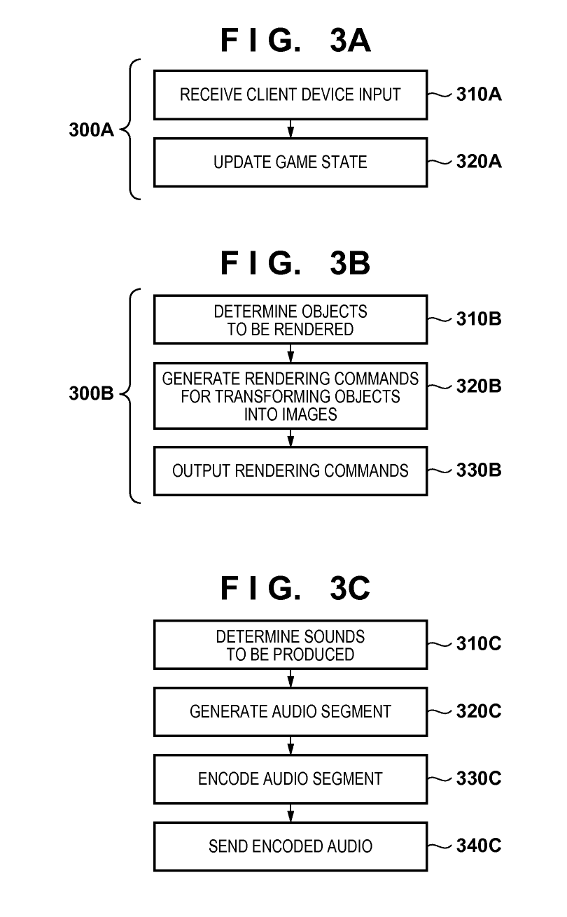

Generation of rendering commands by the video game functional module 270 is now described in greater detail with reference to FIGS. 2C, 3A and 3B. Specifically, execution of the video game functional module 270 may involve several processes, including a main game process 300A and a graphics control process 300B, which are described herein below in greater detail.

VI. Main Game Process

The main game process 300A is described with reference to FIG. 3A. The main game process 300A may execute repeatedly as a continuous loop. As part of the main game process 300A, there may be provided an action 310A, during which client device input may be received. If the video game is a single-player video game without the possibility of spectating, then client device input (e.g., client device input 140) from a single client device (e.g., client device 120) is received as part of action 310A. If the video game is a multi-player video game or is a single-player video game with the possibility of spectating, then the client device input (e.g., the client device input 140 and 140A) from one or more client devices (e.g., the client devices 120 and 120A) may be received as part of action 310A.

By way of non-limiting example, the input from a given client device may convey that the user of the given client device wishes to cause a character under his or her control to move, jump, kick, turn, swing, pull, grab, etc. Alternatively or in addition, the input from the given client device may convey a menu selection made by the user of the given client device in order to change one or more audio, video or gameplay settings, to load/save a game or to create or join a network session. Alternatively or in addition, the input from the given client device may convey that the user of the given client device wishes to select a particular camera view (e.g., first-person or third-person) or reposition his or her viewpoint within the virtual world.

At action 320A, the game state may be updated based at least in part on the client device input received at action 310A and other parameters. Updating the game state may involve the following actions:

Firstly, updating the game state may involve updating certain properties of the participants (player or spectator) associated with the client devices from which the client device input may have been received. These properties may be stored in the participant database 10. Examples of participant properties that may be maintained in the participant database 10 and updated at action 320A can include a camera view selection (e.g., 1^{st} person, 3^{rd} person), a mode of play, a selected audio or video setting, a skill level, a customer grade (e.g., guest, premium, etc.).

Secondly, updating the game state may involve updating the attributes of certain objects in the virtual world based on an interpretation of the client device input. The objects whose attributes are to be updated may in some cases be represented by two- or three-dimensional models and may include playing characters, non-playing characters and other objects. In the case of a playing character, attributes that can be updated may include the object's position, strength, weapons/armor, lifetime left, special powers, speed/direction (velocity), animation, visual effects, energy, ammunition, etc. In the case of other objects (such as background, vegetation, buildings, vehicles, score board, etc.), attributes that can be updated may include the object's position, velocity, animation, damage/health, visual effects, textual content, etc.

It should be appreciated that parameters other than client device input may influence the above properties (of participants) and attributes (of virtual world objects). For example, various timers (such as elapsed time, time since a particular event, virtual time of day, total number of players, a participant's geographic location, etc.) can have an effect on various aspects of the game state.

Once the game state has been updated further to execution of action 320A, the main game process 300A may return to action 310A, whereupon new client device input received since the last pass through the main game process is gathered and processed.

VII. Graphics Control Process

A second process, referred to as the graphics control process, is now described with reference to FIG. 3B. Although shown as separate from the main game process 300A, the graphics control process 300B may execute as an extension of the main game process 300A. The graphics control process 300B may execute continually resulting in generation of the sets of rendering commands 204. In the case of a single-player video game without the possibility of spectating, there is only one player and therefore only one resulting set of rendering commands 204 to be generated. In the case of a multi-player video game, multiple distinct sets of rendering commands need to be generated for the multiple players, and therefore multiple sub-processes may execute in parallel, one for each player. In the case of a single-player game with the possibility of spectating, there may again be only a single set of rendering commands 204, but the resulting video data stream may be duplicated for the spectators by the rendering functional module 280. Of course, these are only examples of implementation and are not to be taken as limiting.

Consider operation of the graphics control process 300B for a given participant requiring one of the video data streams 205. At action 310B, the video game functional module 270 may determine the objects to be rendered for the given participant. This action may include identifying the following types of objects:

Firstly, this action may include identifying those objects from the virtual world that are in the “game screen rendering range” (also known as a “scene”) for the given participant. The game screen rendering range may include a portion of the virtual world that would be “visible” from the perspective of the given participant's camera. This may depend on the position and orientation of that camera relative to the objects in the virtual world. In a non-limiting example of implementation of action 310B, a frustum may be applied to the virtual world, and the objects within that frustum are retained or marked. The frustum has an apex which may be situated at the location of the given participant's camera and may have a directionality also defined by the directionality of that camera.

Secondly, this action can include identifying additional objects that do not appear in the virtual world, but which nevertheless may need to be rendered for the given participant. For example, these additional objects may include textual messages, graphical warnings and dashboard indicators, to name a few non-limiting possibilities.

At action 320B, the video game functional module 270 may generate a set of commands for rendering into graphics (video data) the objects that were identified at action 310B. Rendering may refer to the transformation of 3-D or 2-D coordinates of an object or group of objects into data representative of a displayable image, in accordance with the viewing perspective and prevailing lighting conditions. This may be achieved using any number of different algorithms and techniques, for example as described in “Computer Graphics and Geometric Modelling: Implementation & Algorithms”, Max K. Agoston, Springer-Verlag London Limited, 2005, hereby incorporated by reference herein. The rendering commands may have a format that in conformance with a 3D application programming interface (API) such as, without limitation, “Direct3D” from Microsoft Corporation, Redmond, Wash., and “OpenGL” managed by Khronos Group, Beaverton, Oreg.

At action 330B, the rendering commands generated at action 320B may be output to the rendering functional module 280. This may involve packetizing the generated rendering commands into a set of rendering commands 204 that is sent to the rendering functional module 280.

VIII. Generation of Graphics Output

The rendering functional module 280 may interpret the sets of rendering commands 204 and produces multiple video data streams 205, one for each participating client device. Rendering may be achieved by the GPUs 240R, 250R, 240H, 250H under control of the CPUs 220R, 222R (in FIG. 2A) or 220H, 222H (in FIG. 2B). The rate at which frames of video data are produced for a participating client device may be referred to as the frame rate.

In an embodiment where there are N participants, there may be N sets of rendering commands 204 (one for each participant) and also N video data streams 205 (one for each participant). In that case, rendering functionality is not shared among the participants. However, the N video data streams 205 may also be created from M sets of rendering commands 204 (where M<N), such that fewer sets of rendering commands need to be processed by the rendering functional module 280. In that case, the rendering functional unit 280 may perform sharing or duplication in order to generate a larger number of video data streams 205 from a smaller number of sets of rendering commands 204. Such sharing or duplication may be prevalent when multiple participants (e.g., spectators) desire to view the same camera perspective. Thus, the rendering functional module 280 may perform functions such as duplicating a created video data stream for one or more spectators.

Next, the video data in each of the video data streams 205 may be encoded by the video encoder 285, resulting in a sequence of encoded video data associated with each client device, referred to as a graphics output stream. In the example embodiments of FIGS. 2A-2C, the sequence of encoded video data destined for client device 120 is referred to as graphics output stream 206, while the sequence of encoded video data destined for client device 120A is referred to as graphics output stream 206A.

The video encoder 285 may be a device (or set of computer-readable instructions) that enables or carries out or defines a video compression or decompression algorithm for digital video. Video compression may transform an original stream of digital image data (expressed in terms of pixel locations, color values, etc.) into an output stream of digital image data that conveys substantially the same information but using fewer bits. Any suitable compression algorithm may be used. In addition to data compression, the encoding process used to encode a particular frame of video data may or may not involve cryptographic encryption.

The graphics output streams 206, 206A created in the above manner may be sent over the Internet 130 to the respective client devices. By way of non-limiting example, the graphics output streams may be segmented and formatted into packets, each having a header and a payload. The header of a packet containing video data for a given participant may include a network address of the client device associated with the given participant, while the payload may include the video data, in whole or in part. In a non-limiting embodiment, the identity and/or version of the compression algorithm used to encode certain video data may be encoded in the content of one or more packets that convey that video data. Other methods of transmitting the encoded video data may occur to those of skill in the art.

While the present description focuses on the rendering of video data representative of individual 2-D images, the present invention does not exclude the possibility of rendering video data representative of multiple 2-D images per frame to create a 3-D effect.

IX. Game Screen Reproduction at Client Device

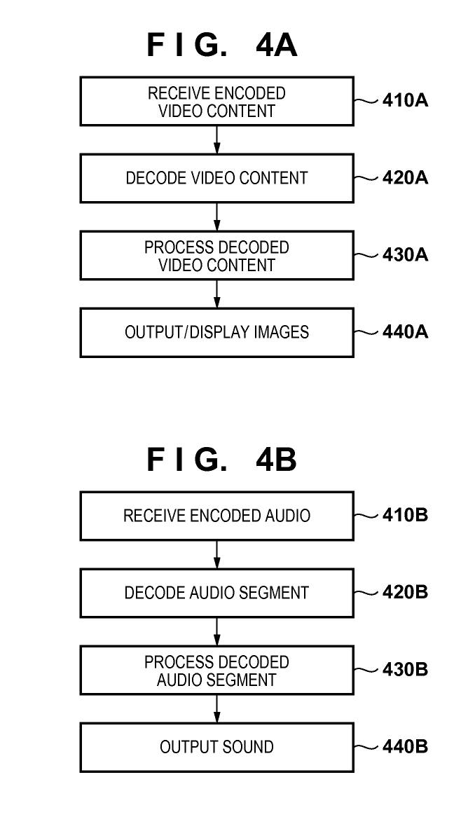

Reference is now made to FIG. 4A, which shows operation of a client-side video game application that may be executed by the client device associated with a given participant, which may be client device 120 or client device 120A, by way of non-limiting example. In operation, the client-side video game application may be executable directly by the client device or it may run within a web browser, to name a few non-limiting possibilities.

At action 410A, a graphics output stream (e.g., 206, 206A) may be received over the Internet 130 from the rendering server 200R (FIG. 2A) or from the hybrid server 200H (FIG. 2B), depending on the embodiment. The received graphics output stream may comprise compressed/encoded of video data which may be divided into frames.

At action 420A, the compressed/encoded frames of video data may be decoded/decompressed in accordance with the decompression algorithm that is complementary to the encoding/compression algorithm used in the encoding/compression process. In a non-limiting embodiment, the identity or version of the encoding/compression algorithm used to encode/compress the video data may be known in advance. In other embodiments, the identity or version of the encoding/compression algorithm used to encode the video data may accompany the video data itself.

At action 430A, the (decoded/decompressed) frames of video data may be processed. This can include placing the decoded/decompressed frames of video data in a buffer, performing error correction, reordering and/or combining the data in multiple successive frames, alpha blending, interpolating portions of missing data, and so on. The result may be video data representative of a final image to be presented to the user on a per-frame basis.

At action 440A, the final image may be output via the output mechanism of the client device. For example, a composite video frame may be displayed on the display of the client device.

X. Audio Generation

A third process, referred to as the audio generation process, is now described with reference to FIG. 3C. The audio generation process may execute continually for each participant requiring a distinct audio stream. In one embodiment, the audio generation process may execute independently of the graphics control process 300B. In another embodiment, execution of the audio generation process and the graphics control process may be coordinated.

At action 310C, the video game functional module 270 may determine the sounds to be produced. Specifically, this action may include identifying those sounds associated with objects in the virtual world that dominate the acoustic landscape, due to their volume (loudness) and/or proximity to the participant within the virtual world.

At action 320C, the video game functional module 270 may generate an audio segment. The duration of the audio segment may span the duration of a video frame, although in some embodiments, audio segments may be generated less frequently than video frames, while in other embodiments, audio segments may be generated more frequently than video frames.

At action 330C, the audio segment may be encoded, e.g., by an audio encoder, resulting in an encoded audio segment. The audio encoder can be a device (or set of instructions) that enables or carries out or defines an audio compression or decompression algorithm. Audio compression may transform an original stream of digital audio (expressed as a sound wave changing in amplitude and phase over time) into an output stream of digital audio data that conveys substantially the same information but using fewer bits. Any suitable compression algorithm may be used. In addition to audio compression, the encoding process used to encode a particular audio segment may or may not apply cryptographic encryption.

It should be appreciated that in some embodiments, the audio segments may be generated by specialized hardware (e.g., a sound card) in either the compute server 200C (FIG. 2A) or the hybrid server 200H (FIG. 2B). In an alternative embodiment that may be applicable to the distributed arrangement of FIG. 2A, the audio segment may be parameterized into speech parameters (e.g., LPC parameters) by the video game functional module 270, and the speech parameters can be redistributed to the destination client device (e.g., client device 120 or client device 120A) by the rendering server 200R.

The encoded audio created in the above manner is sent over the Internet 130. By way of non-limiting example, the encoded audio input may be broken down and formatted into packets, each having a header and a payload. The header may carry an address of a client device associated with the participant for whom the audio generation process is being executed, while the payload may include the encoded audio. In a non-limiting embodiment, the identity and/or version of the compression algorithm used to encode a given audio segment may be encoded in the content of one or more packets that convey the given segment. Other methods of transmitting the encoded audio may occur to those of skill in the art.

Reference is now made to FIG. 4B, which shows operation of the client device associated with a given participant, which may be client device 120 or client device 120A, by way of non-limiting example.

At action 410B, an encoded audio segment may be received from the compute server 200C, the rendering server 200R or the hybrid server 200H (depending on the embodiment). At action 420B, the encoded audio may be decoded in accordance with the decompression algorithm that is complementary to the compression algorithm used in the encoding process. In a non-limiting embodiment, the identity or version of the compression algorithm used to encode the audio segment may be specified in the content of one or more packets that convey the audio segment.

At action 430B, the (decoded) audio segments may be processed. This may include placing the decoded audio segments in a buffer, performing error correction, combining multiple successive waveforms, and so on. The result may be a final sound to be presented to the user on a per-frame basis.

At action 440B, the final generated sound may be output via the output mechanism of the client device. For example, the sound may be played through a sound card or loudspeaker of the client device.

XI. Specific Description of Non-Limiting Embodiments

A more detailed description of certain non-limiting embodiments of the present invention is now provided.

<State Saving Processing>

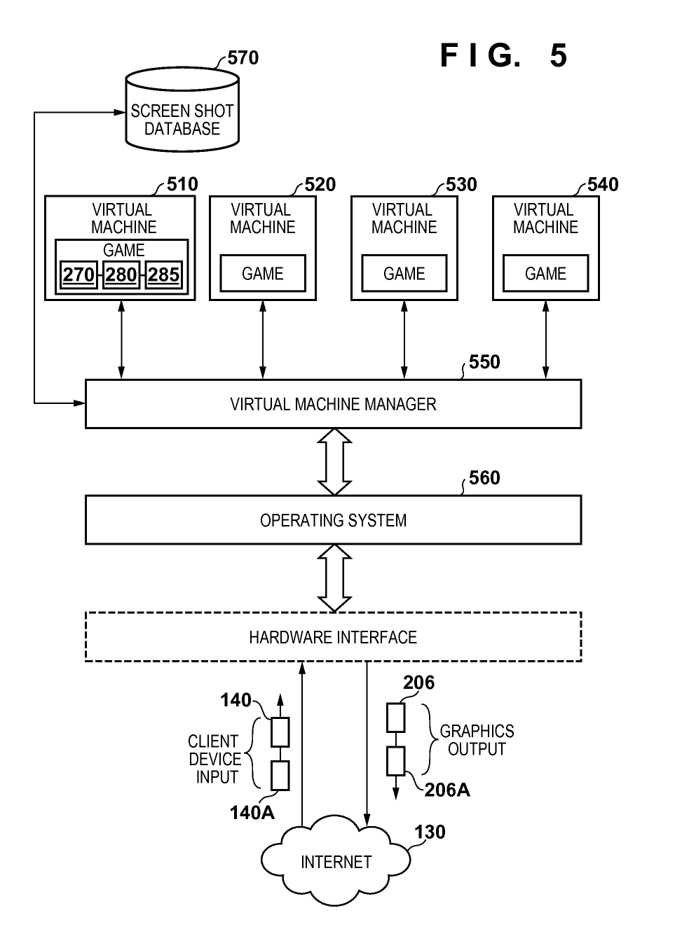

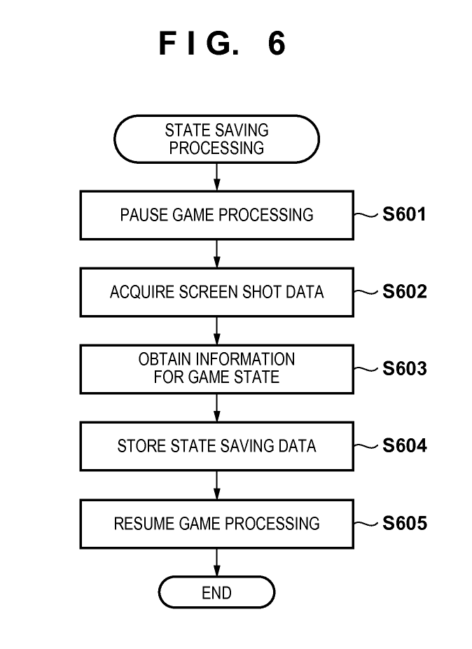

Explanation will be given of specific processing for state saving processing on a server side (the server system 100, the compute server 200C and the rendering server 200R, or the hybrid server 200H), according to embodiments of the present invention, executed in a system having this kind of configuration, using the block diagram of FIG. 5 and the flowchart of FIG. 6.

FIG. 5 shows a configuration of the server side upon provision of media output to a client device including state saving processing. In the example of FIG. 5, game processing for providing game screens (graphics output 206), which is media output to each of the client devices, is executed in virtual machines 510-540 constructed by a virtual machine manager 550, for example. In other words, each virtual machine is arranged as an entity for executing processing for the above described the video game functional module 270, the rendering functional module 280 and the video encoder 285. The virtual machine manager 550 constructs a virtual machine for executing game processing for a client device when a request for game screen provision is received from the client device, for example, and causes it to execute the processing. It also manages a state of the constructed virtual machine.

Each virtual machine virtually comprises hardware such as a CPU, a GPU, and a VRAM, and executes the game processing while making commands, and the like to this virtual hardware. A command made to the virtual hardware is converted into a command to corresponding hardware arranged on the server side via the virtual machine manager 550, and processed by actual hardware. Then the virtual machine manager 550 returns a result of the processing by the actual hardware to the corresponding virtual machine. By doing this, a virtual machine can function as a single entity for executing (emulating) operations equivalent to actual hardware such as a game console.

In the example of FIG. 5, a command transmission to the actual hardware is performed via the operating system 560 managing a hardware interface. Specifically, the virtual machine manager 550 transmits to the operating system 560 when a command to the virtual hardware that originated in the virtual machine is obtained. Then, when operation for the command is executed in the corresponding hardware, the virtual machine manager 550 receives, via the operating system 560, and returns to the virtual machine, a result.

In this embodiment, the operating system 560 has a so-called screen shot function for capturing a screen loaded into a screen memory of the VRAM 246, or the like. In this embodiment, capture target screens are game screens generated by execution of game processing in a virtual machine. In cases where the CPU 222 obtains a screen shot of a game screen generated by processing on a virtual machine, it performs acquisition of the target game screen employing that function of the operating system 560. A screen shot of a game screen obtained in this way is stored by the virtual machine manager 550 in the screen shot database 570. Also, in this embodiment, the screen shot database 570 records state information indicating a progress status of a game corresponding to the screen shot in association with the screen shot.

In this embodiment, explanation is given having data communication between the virtual machines and the client devices be realized via the virtual machine manager 550 and the operating system 560, but working of the present invention is not limited to this. In other words, the virtual machine manager 550 may perform data exchange by a direct hardware interface without going through the operating system 560, or the operating system 560 may perform data exchange directly with the virtual machines. Also, in this embodiment, explanation is given having game processing be executed by constructing a virtual machine as an emulator of an execution environment or a predetermined game console, for example, but the construction of a virtual machine is not necessary in the working of the present invention. In other words, so long as parallel processing, and game processing corresponding to the client devices can be executed in parallel for a plurality of client devices on the server side, embodiment of the present invention is possible without constructing a virtual machine.

Next, for the state saving processing performed on the server side of this kind of configuration, detailed explanation will be given using the flowchart of FIG. 6. The processing corresponding to this flowchart can be realized by the CPU 222 reading out a corresponding processing program stored in a storage medium (not shown), for example, loading it into the RAM 230, and executing it.

In the following explanation, explanation is given having the state saving processing be initiated when a screen shot recording instruction is made for state saving by a player, as an example of a state saving request. Specifically, in a case where the virtual machine manager 550 outputs a notification indicating that the instruction was made in game processing being executed on the virtual machine, the CPU 222 initiates this processing. However, the execution timing of this processing is not limited to this, and may be executed at a predetermined time interval, or when an operation character or a state of a virtual world (game world) expressed in the executed game satisfies a predetermined condition (a character level up, a world transition, etc.). Alternatively, this may be executed in accordance with a recording instruction from a spectator spectating the gameplay on the client device 120A which receives media output 150A of the same content as the media output 150 provided to the client device 120 of the player, and is not limited to just the player.

In step S601, the CPU 222 pauses the game processing in a virtual machine (target VM) that received a screen shot recording instruction from the player. Specifically, the CPU 222 commands the virtual CPU of the target VM to pause the game processing via the virtual machine manager 550.

In step S602, the CPU 222 acquires, as screen shot data, a game screen for game processing currently stored in the virtual VRAM of the target VM. Specifically, the CPU 222 reads out a corresponding game screen stored in either of the VRAMs 246 and 256, and stores, as screen shot data, into the RAM 230, for example.

In step S603, the CPU 222 obtains information for the game ID, the player ID and the game state in the game processing executed on the target VM, and stores into the RAM 230. Information for the game state indicates information that can at least reproduce a similar game state in a case where the game processing is executed using this information, and can generate the same screen as a game screen of a frame corresponding to the recording instruction. In this embodiment, the information for the game state will be explained as something in which
state information
resource loading information
   are included.

Here, the game ID is information for identifying the game executed in the game processing. The player ID is information that identifies a player operating the client device 120 receiving the provision of game screens generated by the processing on the target VM, is set for each player upon a user account registration performed beforehand, and is information which identifies that player uniquely. The state is a state generated in game processing executed on the target VM which includes at least one of a progress status of the game, various variables, or predetermined calculation results, for example. In the state in this embodiment is state information such as at least information including information necessary for generating a game screen of a frame corresponding to a recording instruction such as a progress status of the game being executed, various variables, and predetermined calculation results. Specifically, in the state information, information such as a position, an orientation of a character, or an operation, or information such as a health of a character, a level, a current difficulty level of the game, a current score, or a high-score may be included. This information may be defined in a predetermined class in a program for the game processing, for example, and an object of that class may be handled as game state information. Also, the resource loading information is information for indicating rendering resource data loaded into a GPU memory (not shown) for rendering objects necessary when a game screen of a frame corresponding to the recording instruction is rendered. The resource loading information may be comprised of information which identifies the rendering object for which the resource data is loaded into the GPU memory, or may be comprised of the resource data itself after loading into the GPU memory. In the latter case, the resource loading information may be something that records the entire virtual GPU memory space for the target VM.

In this embodiment, explanation is given having the game ID and the player ID be obtained in addition to information for the game state, but working of the present invention is not limited to this. For example, it should be easily understood that in cases where the server side only provides a single game content item, or in cases such as when a player account is created for each game content item, it is not necessary to obtain the game ID. Also, other than the information listed above, the state information may include data that is not related directly to the rendering of the game screen such as an elapsed time from the initiation of the game processing, for example.

In step S604, the virtual machine manager 550, under the control of the CPU 222, associates screen shot data stored in the RAM 230 and information for the game state, and stores in the screen shot database 570 as state saving data. Specifically, the virtual machine manager 550, first referencing the player ID stored in the RAM 230, reads out state saving information stored for a player of the target VM. Then, the virtual machine manager 550 adds, as one record, new state saving data, into a region corresponding to the game ID within the state saving information, and updates the state saving information for the player by storing into the screen shot database 570 the state saving information after adding.

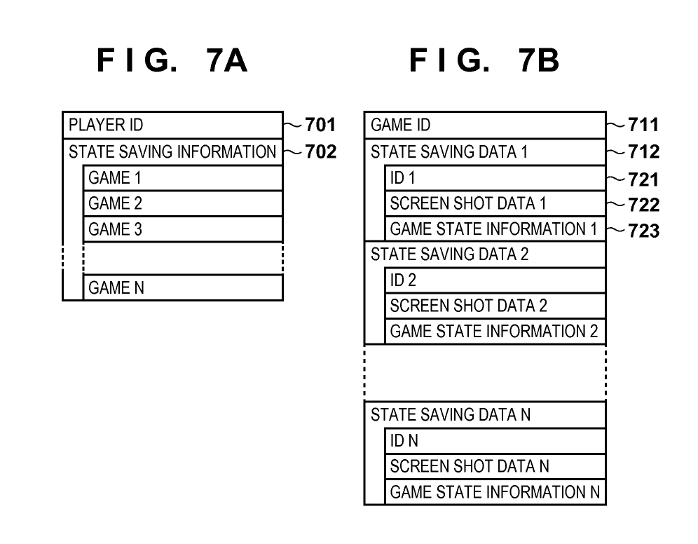

The state saving information of this embodiment is comprised of constituent elements as shown in FIGS. 7A and 7B. FIG. 7A shows a data configuration of the state saving information for the player. As shown in the figure, the state saving information is comprised of an associated player ID 701 and state saving information 702. Also, the state saving information 702 comprises an area for storing state saving data (a record) of each game for each of the games that generated state saving data so that the state saving data can be managed for each game as explained above. The region for storing the state saving data of each game is arranged in association with the game ID 711, as shown in FIG. 7B, for example. As shown in the figure, state saving data 712 are stored in this area for the number of times the recording instruction was made, i.e. for the number of times the state saving processing was executed for this game. A unique ID 721 is allocated sequentially when state saving data 712 is added, and the state saving data 712 is stored as data for which along with this ID, screen shot data 722, and information 723 for the game state are associated.

In the explanation of this step, in the case where there is no area for storing the state saving data for the game or the state saving information for the player, similar processing may be performed by the virtual machine manager 550 newly generating the corresponding information.

In step S605, the CPU 222 resumes the game processing in the target VM paused in step S601, and completes the state saving processing.

By doing this, information for the game state corresponding to the game content item according to the screen shot recording instruction can be saved in the system. Also, by using information for the saved game state in the game processing, it is possible to resume the game by generating an equivalent game screen to when the screen shot recording instruction was made. For example, in cases where it is desired that the game be resumed from the place where the player made the screen shot recording instruction, the virtual CPU of the target VM may obtain the state saving information for the provided game via the virtual machine manager 550, generate a screen for selecting a resume target state in accordance with this information, and transmit it to the client device. Here, because the screen shot data is associated with the information for the game state, it is possible to include the screen shot data in the screen for selecting the resume target state. In other words, by the player making the screen shot recording instruction, it is possible to create save data with which it is possible to resume from any timing in the game. Also, because the player is able to view a screen shot corresponding to the save data when the game is resumed using this save data, the desired resume point can be identified easily.

<State Sharing Processing>

The player in the system of this embodiment is not only able to use the state saving data generated by the above described state saving processing for saving/resuming his or her own game progress, but is also able to share with another player. In other words, by sharing the state saving data that the player generated during game play with another player, the player is able to allow another player to play continuing from his or her own game play. Alternatively, game play can be performed continuing from there using the state saving data that the other player generated.

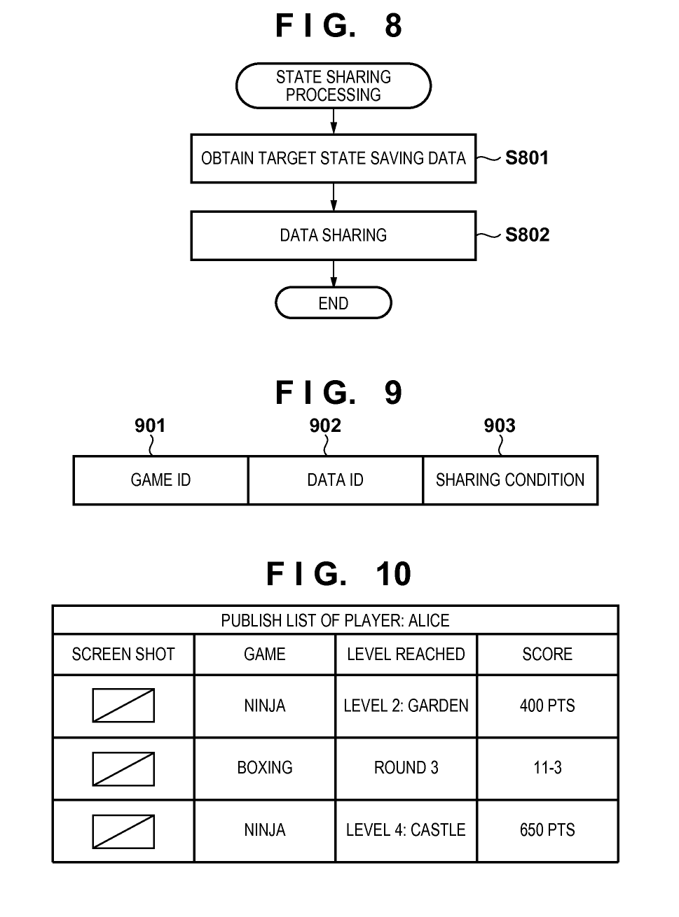

Below, detailed explanation will be given with reference to the flowchart of FIG. 8 for the state sharing processing making possible this kind of the state saving data sharing. The processing corresponding to this flowchart can be realized by the CPU 222 reading out a corresponding processing program stored in a storage medium (not shown), for example, loading into the RAM 230, and executing. In the following explanation, the state sharing processing will be explained as something that is initiated when a sharing instruction is made by the player to publish the state saving data in a state that another player is capable of using, as an example of a state saving data sharing request. Specifically, the CPU 222 initiates this processing in cases where it determines that a sharing instruction is received from a client device. However, the execution timing of this processing is not limited to this, and may be executed in cases where state saving data is newly generated by the above described state saving processing. Alternatively, this may be executed in cases where the player consents to a state saving data sharing instruction made by another player. Also, similarly to the state saving processing, this processing may be initiated in cases where the sharing instruction is made by a player during game play.

In step S801, the CPU 222 obtains state saving data (target state saving data) which is the target of the sharing instruction. Here, the target state saving data is not limited to a single state saving data item, and may be a plurality of state saving data items. Specifically, the CPU 222, in accordance with information included in the sharing instruction, reads out target state saving data from the screen shot database 570 via the virtual machine manager 550, and stores in the RAM 230.

The sharing instruction may be comprised of a game ID 901, a data ID 902, and a sharing condition 903, as shown in FIG. 9, for example. Here, the data ID 902 is information which identifies the target state saving data, and may be an ID 721 allocated to state saving data in the state saving processing. Also, the sharing condition 903 is information for showing which other players to share the target state saving data. The sharing condition 903 may include the player ID of a player in cases of sharing with a particular player, for example, and may include information indicating publishing in cases of publishing without restricting which player can use it. Other than this, information specifying a medium, or a method to be used for the sharing of an SNS (social network service), an Internet bulletin board or a mail may be included in the sharing condition 903.

Accordingly, the CPU 222, in accordance with information of the data ID 902 is included in the sharing instruction, obtains the target state saving data from the screen shot database 570 and stores to the RAM 230.

In step S802, the CPU 222, referencing the sharing condition 903 included in the sharing instruction, performs the sharing of the target state saving data in accordance with a specified sharing method, and the state sharing processing completes.

Here, as a concrete example, a case in which the target state saving data is published as a player posting in a particular SNS is considered. The CPU 222, referencing information for screen shot data, the game ID, and the game state of the target state saving data stored in the RAM 230, generates data of a publishing list such as that of FIG. 10. In the example of FIG. 10, in the target state saving data shared by the player is shown a screen shot at the time the state saving data was obtained, a game name, a stage in the game (a game progress status), and a score. In the publishing list, information (link information) for performing an access request for corresponding state saving data is associated with an image of the screen shot. By another user using the SNS clicking the image of the screen shot, for example, after the list is published by the posting, a client terminal of that user connects to the server system 100, and the user can play the corresponding game from the state according to the screen shot. Here, the CPU 222 causes the virtual machine manager 550 to construct a virtual machine for execution of the game with that user as the player. Also, the virtual machine manager 550, under the control of the CPU 222, reads out from the screen shot database 570, and transmits to the constructed virtual machine, the corresponding state saving data. Here, the virtual machine manager 550 copies the read out state saving data to state saving information associated with a player corresponding to a transmission destination virtual machine, and associates the state saving data with a transmission destination player ID. Then, consecutive game screens are sequentially transmitted to the client device, with the game screen corresponding to the screen shot as an initiation frame, by the virtual CPU of the virtual machine performing game processing based on the state saving data.

As for the method for sharing the state saving data, various applications can be considered other than this. For example, in cases where a player reaches a scene or scenario in the game play for which is it difficult to progress, by the player generating state saving data with a screen shot recording instruction, and sharing that data with another player, it is possible to get the other player to play the portion of the scene that is difficult in the game in one's place. Also, by getting the other player to generate state saving data after playing the difficult portion of the scene, and to share that data, is possible for the user to resume the game from after the difficult portion of the scene.

Also, during game play, the player may create state saving data for a particular game state such as a state where a character surrounded by many enemy characters, or create a state where there is only a small amount of remaining health, for example. Then a system may be constructed so that it is possible for players to compete between themselves by sharing their clearing of the game with a highest score or with a shortest play time, for example, when state saving data is shared having set up a theme such as to clear the game from the created state in which the game play is restricted. Specifically, configuration may be taken such that the CPU 222 obtains a play result of the game initiated using one state saving data item, for example, and publishes results (rankings) of a tally at predetermined time periods to a particular site.

Also, in cases where the player wishes to initiate a predetermined game, the player is able to enjoy a game in a state in which the game progress is easy, i.e. in a state in which the difficulty level is lowered, by using state saving data generated by another player in a state in which a level of a character is raised, or a state in which equipment that a character possesses is enhanced, for example. Other than this, configuration may be taken such that buying and selling the state saving data between players on an auction site, for example, is possible, and the corresponding state saving data from the state saving information of a player is deleted when passed to another player. Also, in such a case, because a game state corresponding to the state saving data can be confirmed easily from the screen shot data, or the state information, the player can perform the transaction safely.

These applications may include information for identifying a selected method in the sharing condition 903, when a state saving data sharing method is prepared beforehand which the player selects upon performing the state saving data sharing instruction.

In this way, in the server system of this embodiment, it is possible to generate state saving data at a particular timing in the game processing executed for one client device, to use this data in order to load a game, and to share easily with another player.

In this embodiment, explanation was given having the game screens generated in video memory be stored as screen shots, but working of the present invention is not limited to this. For example, a difference with a screen shot included in the state saving data stored immediately before and an obtained screen shot may be extracted and the data of the difference may be stored as the screen shot. In such a case, a capacity of the state saving data stored in the screen shot database 570 can be reduced.

Also, in this embodiment, explanation was given for an example in which the state saving data is generated based on an operation that a player, or the like, actively performs, such as generating the state saving data in accordance with a request from the player, or a spectator, and game progress statuss, but working of the present invention is not limited to this. For example, configuration may be taken such that the state saving data is configured such that it is generated in cases where a communication connection between a client device and a server system 100 is disconnected due to a power discontinuity of the client device, a communication failure, or the like, in cases where interrupt processing such as for a mail receipt in the client device, or the like, occurs, or cases where a state occurs in which it is desirable for the player to stop game processing due to an unintended event.

Also, regarding the image of the screen shot generated for the recording instruction of the state saving data, an access link may be generated when one can view the image directly, or the image may be transmitted to a mail address of a player.

Note, in this embodiment, explanation was given having a condition that the state saving data specifies be recorded in association with screen shot data in order to make it clear, but working of the present invention is not limited to this. For example, in order to make clear the condition that the state saving data specifies, rather than the screen shot data, moving image data comprised of game screens of several frames previous to when the state saving is performed may be recorded. In particular, in a cloud gaming system, because game screens are encoded and provided to client devices, configuration is taken so as to retain game screens across a few frames in order to perform predictive encoding between frames in the encoding, and including moving image data in the state saving data is easy. Also, configuration may be taken such that other than the moving image data, text data specifying a condition in the game such as a progress status of the game, an action history, or the like, for example, or data which substitutes for these may be associated. Also, at least two of screen shot data, moving image data and text data may be associated integrally.

In this embodiment, explanation was given for an example in which the present invention is realized in a cloud gaming system as explained using FIGS. 1A, 1B, 2A, 2B and 2C, but working of the present invention is not limited to this. For example, for the present invention, the state saving data generated in the client device can be adopted to a system in which sharing with another client device is possible. Specifically, in a case where game processing is executed in a client device, the CPU of that device similarly can generate state saving data by obtaining information for screen shot data and a game state. The generated state saving data is stored within the client device or in an external device such as a server on a network, for example, and sharing becomes possible. In cases where a sharing instruction is made, because the CPU of the client device can obtain link information of the state saving data, it is possible to share the link information of the state saving data by transmitting to another client device. In such a case, the resource is not always loaded into a storage area of fixed hardware as in the above described embodiment, but rather is loaded into a storage area of hardware having differing usage depending on the client device. Consequently, in cases where the data itself is loaded into a GPU memory, as in the above described embodiment, as resource loading information, there is the possibility that this information cannot be used by a client device. Also, the existence or absence of a GPU memory into which a resource is loaded, an address of a loading destination, or a data capacity of a resource loaded for the same object, changes based on the device on which the game processing is executed. Accordingly, in cases when the present invention is realized in the client device, it is advantageous that resource loading information indicate identifier information of a loaded resource.

As explained above, the game apparatus of this embodiment is able to provide state saving data easily to another device. Specifically, a game apparatus obtains in a case where a state saving request is received, information specifying a condition in a game corresponding to that request and state information for initiating a game in a same state as a game screen corresponding to that request and records state saving data associated with the condition information and the state information. The game apparatus provides, in a case where a state saving data sharing request is received, link information of the recorded state saving data and condition information for that data, to another device.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Also, the game system, the game apparatus and the control method according to the present invention are realizable by a program executing the methods on a computer. The program is providable/distributable by being stored on a computer-readable storage medium or through an electronic communication line.

This application claims the benefit of U.S. Provisional Patent Application No. 61/761,374, filed Feb. 6, 2013, which is hereby incorporated by reference herein in its entirety.

1. A game system for executing games for each of a plurality of client devices, and providing game screens for an executing game to a corresponding client device, the system comprising:
an executor which is able to execute processing for a game, and generate game screens;
a condition obtainer which is able to obtain, in a case where a state saving request is received, condition information specifying a condition in a game corresponding to that request;
a state obtainer which is able to obtain, in a case where the state saving request is received, state information for initiating a game in a same state as a game screen corresponding to that request;
a recorder which is able to record the condition information and the state information as state saving data; and
a provider which is able to provide, in a case where a state saving data sharing request is received, link information of the state saving data recorded by the recorder and condition information for that data, to a client device different from a client device to which a game screen corresponding to that state saving data was provided, wherein
in a case where an access request based on the link information of the state saving data is received from the client device to which the link information of that state saving data provided by the provider, the executor obtains that state saving data, and executes processing for the game from a same state as that of a game screen corresponding to that state saving data.

2. A game apparatus for executing a game, the apparatus comprising:
an executor which is able to execute processing for a game, and generate game screens;
a condition obtainer which is able to obtain, in a case where a state saving request is received, information specifying a condition in a game corresponding to that request;
a state obtainer which is able to obtain, in a case where the state saving request is received, state information for initiating a game in a same state as a game screen corresponding to that request;
a recorder which is able to record state saving data associated with the condition information and the state information; and
a provider which is able to provide, in a case where a state saving data sharing request is received, link information of the state saving data recorded by the recorder and condition information for that data, to an external device.

3. The game apparatus according to claim 2, further comprising a receiver which is able to receive an access request based on the link information of the state saving data recorded by the recorder, or an access request based on link information of state saving data provided by an external apparatus, and wherein
the executor obtains the state saving data for which the access request was received by the receiver, and executes processing for the game from a same state as that of a game screen corresponding to that data.

4. The game apparatus according to claim 2, wherein the condition information is at least one of screen data for the game screen corresponding to the state saving request, moving image data, or text data indicating a state in the game.

5. The game apparatus according to claim 2, wherein the state information includes at least one of a progress status of the game, variables used for the game, or calculation results.

6. The game apparatus according to claim 2, wherein the executor performs generation of a game screen by using a resource loaded into a predetermined storage area, and
the state information includes data of the resource loaded into the predetermined storage area in order to generate a corresponding game screen.

7. The game apparatus according to claim 2, wherein the executor performs generation of a game screen by using a resource loaded into a predetermined storage area, and
the state information includes information for identifying the resource loaded into the predetermined storage area in order to generate a corresponding game screen.

8. The game apparatus according to claim 2, wherein the sharing request includes information identifying a method for the provider provides the link information and the condition information, and
the provider provides, based on the information specifying the provision way, link information of state saving data, and screen data for that data to an external apparatus.

9. A method of controlling a game apparatus for executing a game, the method comprising:
executing processing for a game, and generating game screens;
obtaining, in a case where a state saving request is received, condition information specifying a condition in a game corresponding to that request;
obtaining, in a case where the state saving request is received, state information for initiating a game in a same state as a game screen corresponding to that request;
recording state saving data associated with the condition information and the state information; and
providing, in a case where a state saving data sharing request is received, link information of the state saving data recorded in the recording of the state saving data and condition information for that data, to an external device.

10. The method of controlling the game apparatus according to claim 9, further comprising:
receiving step of receiving an access request based on the link information of the state saving data recorded by in the recording of the state saving data, or an access request based on link information of state saving data provided by an external apparatus, and wherein
the state saving data for which the access request was received in the receiving is obtained, and processing for the game is executed from a same state as that of a game screen corresponding to that data in the executing of the processing for the game.

11. The method of controlling the game apparatus according to claim 9, wherein the condition information is at least one of screen data for the game screen corresponding to the state saving request, moving image data, or text data indicating a state in the game.

12. The method of controlling the game apparatus according to claim 9, wherein the state information includes at least one of a progress status of the game, variables used for the game, or calculation results.

13. The method of controlling the game apparatus according to claim 9, wherein generation of a game screen is performed by using a resource loaded into a predetermined storage area in the executing of the processing for the game, and
the state information includes data of the resource loaded into the predetermined storage area in order to generate a corresponding game screen.

14. The method of controlling the game apparatus according to claim 9, wherein generation of a game screen is performed by using a resource loaded into a predetermined storage area in the executing of the processing for the game, and
the state information includes information for identifying the resource loaded into the predetermined storage area in order to generate a corresponding game screen.

15. The method of controlling the game apparatus according to claim 9, wherein the sharing request includes information identifying a method for the providing of the link information and the condition information, and
in the providing, based on the information specifying the provision way, link information of state saving data, and screen data for that data is provided to an external apparatus.

16. A non-transitory computer-readable storage medium storing a program for causing one or more computers to execute the method of controlling the game apparatus according to claim 9.

17. (canceled)
